(19) United States
(12) Patent Application Publication
(10) Pub. No.: US 2015/0049727 A1
(43) Pub. Date: Feb. 19, 2015

(54) UPLINK SDMA TRANSMIT OPPORTUNITY SCHEDULING

(71) Applicant: QUALCOMM Incorporated, San Diego, CA (US)

(72) Inventors: Maarten Menzo Wentink, Naarden (NL); Simone Merlin, Solana Beach, CA (US)

(21) Appl. No.: 14/527,581

(22) Filed: Oct. 29, 2014

Related U.S. Application Data
(63) Continuation-in-part of application No. 12/888,221, filed on Sep. 22, 2010.
(60) Provisional application No. 61/245,145, filed on Sep. 23, 2009.

(51) Int. Cl. H04W 72/12

(52) U.S. Cl. CPC H04W 72/1257
USPC 370/329

(57) ABSTRACT

Certain aspects of the present disclosure present medium access control (MAC) protocols for uplink Spatial Division Multiple Access (SDMA) transmissions by one or more stations (STAs). An access point (AP) may receive one or more requests for uplink SDMA transmission from a plurality of stations. The access point may schedule the transmissions by sending a signal to the stations to notify them of the parameters of the uplink SDMA transmissions such as start time, duration of the transmission, spatial streams assigned to each station, and so on.

### CROSS REFERENCE TO RELATED APPLICATIONS

The present application for patent is a continuation-in-part of patent application Ser. No. 12/888,221, entitled, “Uplink SDMA Transmit Opportunity Scheduling,” filed Sep. 22, 2010, pending, which claims priority to U.S. Provisional Application Ser. No. 61/245,145, entitled, “Uplink SDMA Transmit Opportunity Scheduling,” filed Sep. 23, 2009, expired, both assigned to the assignee hereof and hereby expressly incorporated by reference herein.

### BACKGROUND

1. Field

Certain aspects of the present disclosure generally relate to wireless communications and, more particularly, to transmit opportunity scheduling in uplink spatial division multiple access (SDMA).

2. Background

In order to address the issue of increasing bandwidth requirements that are demanded for wireless communications systems, different schemes are being developed to allow multiple user terminals to communicate with a single access point (AP) by sharing the channel resources while achieving high data throughputs. Multiple Input or Multiple Output (MIMO) technology represents one such approach that has recently emerged as a popular technique for the next generation communication systems. MIMO technology has been adopted in several emerging wireless communications standards such as the Institute of Electrical and Electronics Engineers (IEEE) 802.11 standard. The IEEE 802.11 denotes a set of Wireless Local Area Network (WLAN) air interface standards developed by the IEEE 802.11 committee for short-range communications, for example, tens of meters to a few hundred meters.

A MIMO wireless system employs a number (N_{T}) of transmit antennas and a number (N_{R}) of receive antennas for data transmission. A MIMO channel formed by the N_{T} transmit and N_{R} receive antennas may be decomposed into N_{S} spatial streams, where, for all practical purposes, N_{S}<=min [N_{T}, N_{R}]. The N_{S} spatial streams may be used to transmit N_{S} independent data streams to achieve greater overall throughput.

In wireless networks with a single access point and multiple stations, concurrent transmissions may occur on multiple channels toward different stations, both in the uplink (UL) and downlink (DL) directions. Many challenges are presented in such systems, such as the ability to communicate with legacy devices in addition to non-legacy devices, efficient use of resources, and interference.

### SUMMARY

Certain aspects of the present disclosure provide a method for wireless communications. The method generally includes receiving, from one or more apparatuses, one or more request messages for a transmission slot for a spatial division multiple access (SDMA) transmission, and transmitting a transmit opportunity (TXOP) start frame to one or more of the apparatuses to indicate start of a SDMA TXOP.

Certain aspects of the present disclosure provide a method for wireless communications. The method generally includes transmitting a request message for a transmission slot for a spatial division multiple access (SDMA) transmission, receiving a transmit opportunity (TXOP) start frame comprising an indication of start of a SDMA transmission, and transmitting SDMA data during a TXOP in accordance with the TXOP start frame.

Certain aspects of the present disclosure provide an apparatus for wireless communications. The apparatus generally includes a receiver configured to receive, from one or more apparatuses, one or more request messages for a transmission slot for a spatial division multiple access (SDMA) transmission, and a transmitter configured to transmit a transmit opportunity (TXOP) start frame to one or more of the apparatuses to indicate start of a SDMA TXOP.

Certain aspects of the present disclosure provide an apparatus for wireless communications. The apparatus generally includes a transmitter configured to transmit a request message for a transmission slot for a spatial division multiple access (SDMA) transmission, a receiver configured to receive a transmit opportunity (TXOP) start frame comprising an indication of start of a SDMA transmission, and wherein the transmitter is further configured to transmit SDMA data during a TXOP in accordance with the TXOP start frame.

Certain aspects of the present disclosure provide an apparatus for wireless communications. The apparatus generally includes means for receiving, from one or more apparatuses, one or more request messages for a transmission slot for a spatial division multiple access (SDMA) transmission, and means for transmitting a transmit opportunity (TXOP) start frame to one or more of the apparatuses to indicate start of a SDMA TXOP.

Certain aspects of the present disclosure provide an apparatus for wireless communications. The apparatus generally includes means for transmitting a request message for a transmission slot for a spatial division multiple access (SDMA) transmission, means for receiving a transmit opportunity (TXOP) start frame comprising an indication of start of a SDMA transmission, and wherein the means for transmitting further comprises means for transmitting SDMA data during a TXOP in accordance with the TXOP start frame.

Certain aspects of the present disclosure provide a computer-program product for wireless communications, comprising a computer-readable medium comprising instructions. The instructions executable for receiving, from one or more apparatuses, one or more request messages for a transmission slot for a spatial division multiple access (SDMA) transmission, and transmitting a transmit opportunity (TXOP) start frame to one or more of the apparatuses to indicate start of a SDMA TXOP.

Certain aspects of the present disclosure provide a computer-program product for wireless communications, comprising a computer-readable medium comprising instructions. The instructions executable for transmitting a request message for a transmission slot for a spatial division multiple access (SDMA) transmission, receiving a transmit opportunity (TXOP) start frame comprising an indication of start of a SDMA transmission, and transmitting SDMA data during a TXOP in accordance with the TXOP start frame.

Certain aspects provide an access point for wireless communications. The access point generally includes a plurality of antennas, a receiver configured to receive, via the plurality of antennas, from one or more apparatuses, one or more request messages for a transmission slot for a spatial division multiple access (SDMA) transmission, and a transmitter configured to transmit a transmit opportunity (TXOP) start frame to one or more of the apparatuses to indicate start of a SDMA TXOP.

Certain aspects provide a station for wireless communications. The station generally includes at least one antenna, a transmitter configured to transmit, via the at least one antenna, a request message for a transmission slot for a spatial division multiple access (SDMA) transmission, a receiver configured to receive a transmit opportunity (TXOP) start frame comprising an indication of start of a SDMA transmission, and wherein the transmitter is further configured to transmit SDMA data during a TXOP in accordance with the TXOP start frame.

Certain aspects provide a method of wireless communication, performed by a access point (AP). The method generally includes transmitting, to one or more apparatuses, an indication of a threshold duration for single-user (SU) transmissions, receiving, from at least one of the one or more apparatuses having data with a corresponding transmission time greater than the indicated threshold duration for SU transmissions, a request message for a transmission slot for a spatial division multiple access (SDMA) transmission for transmitting the data, and transmitting a transmit opportunity (TXOP) start frame to the at least one apparatus to indicate start of a SDMA TXOP.

Certain aspects provide a method of wireless communication, performed by a station (STA). The method generally includes receiving, from an access point, an indication of a threshold duration for single-user (SU) transmissions, determining a transmission time of data will exceed the threshold duration for SU transmissions, and transmitting a request message for a transmission slot for a spatial division multiple access (SDMA) transmission, in response to the determination.

Certain aspects provide an apparatus for wireless communication. The apparatus generally includes means for transmitting, to one or more apparatuses, an indication of a threshold duration for single-user (SU) transmissions, means for receiving, from at least one of the one or more apparatuses having data with a corresponding transmission time greater than the indicated threshold duration for SU transmissions, a request message for a transmission slot for a spatial division multiple access (SDMA) transmission for transmitting the data, and means for transmitting a transmit opportunity (TXOP) start frame to the at least one apparatus to indicate start of a SDMA TXOP.

Certain aspects provide an apparatus for wireless communication. The apparatus generally includes means for receiving, from an access point, an indication of a threshold duration for single-user (SU) transmissions, means for determining a transmission time of data will exceed the threshold duration for SU transmissions, and means for transmitting a request message for a transmission slot for a spatial division multiple access (SDMA) transmission, in response to the determination.

Certain aspects provide an apparatus for wireless communication. The apparatus generally includes a transmitter for transmitting, to one or more apparatuses, an indication of a threshold duration for single-user (SU) transmissions and a receiver for receiving, from at least one of the one or more apparatuses having data with a corresponding transmission time greater than the indicated threshold duration for SU transmissions, a request message for a transmission slot for a spatial division multiple access (SDMA) transmission for transmitting the data, wherein the transmitter is also for transmitting a transmit opportunity (TXOP) start frame to the at least one apparatus to indicate start of a SDMA TXOP.

Certain aspects provide an apparatus for wireless communication. The apparatus generally includes a receiver for receiving, from an access point, an indication of a threshold duration for single-user (SU) transmissions, a processing system for determining a transmission time of data will exceed the threshold duration for SU transmissions, and a transmitter for transmitting a request message for a transmission slot for a spatial division multiple access (SDMA) transmission, in response to the determination.

Certain aspects provide a computer-program product for wireless communications, comprising a computer-readable medium. The computer-readable medium generally includes instructions executable for transmitting, to one or more apparatuses, an indication of a threshold duration for single-user (SU) transmissions, receiving, from at least one of the one or more apparatuses having data with a corresponding transmission time greater than the indicated threshold duration for SU transmissions, a request message for a transmission slot for a spatial division multiple access (SDMA) transmission for transmitting the data, and transmitting a transmit opportunity (TXOP) start frame to the at least one apparatus to indicate start of a SDMA TXOP.

Certain aspects provide a computer-program product for wireless communications, comprising a computer-readable medium. The computer-readable medium generally includes instructions executable for receiving, from an access point, an indication of a threshold duration for single-user (SU) transmissions, determining a transmission time of data will exceed the threshold duration for SU transmissions, and transmitting a request message for a transmission slot for a spatial division multiple access (SDMA) transmission, in response to the determination.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates a diagram of a wireless communications network in accordance with certain aspects of the present disclosure.

FIG. 2 illustrates a block diagram of an example access point and user terminals in accordance with certain aspects of the present disclosure.

FIG. 3 illustrates a block diagram of an example wireless device in accordance with certain aspects of the present disclosure.

FIG. 4 illustrates an example network consisting of an access point and a plurality of stations, in accordance with certain aspects of the present disclosure.

FIG. 5 illustrates message exchange between an access point and two stations utilizing enhanced distributed channel access (EDCA) procedure.

FIG. 6 illustrates message exchange between an access point and two stations utilizing uplink SDMA procedure, in accordance with certain aspects of the present disclosure.

FIG. 7 illustrates a comparison between an EDCA protocol and a proposed uplink SDMA protocol, in accordance with certain aspects of the present disclosure.

FIG. 8 illustrates example operations for performing uplink spatial division multiple access (SDMA) that may be employed by an access point, in accordance with certain aspects of the present disclosure.

FIG. 8A illustrates example components capable of performing the operations shown in FIG. 8.

FIG. 9 illustrates example operations for performing uplink SDMA that may be employed by a station, in accordance with certain aspects of the present disclosure.

FIG. 9A illustrates example components capable of performing the operations shown in FIG. 9.

FIG. 10 illustrates example operations for wireless communications, in accordance with certain aspects of the present disclosure.

### DETAILED DESCRIPTION

Various aspects of the present disclosure are described below. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. Furthermore, an aspect may comprise at least one element of a claim.

The word “exemplary” is used herein to mean “serving as an example, instance, or illustration.” Any aspect described herein as “exemplary” is not necessarily to be construed as preferred or advantageous over other aspects. Also as used herein, the term “legacy stations” generally refers to wireless network nodes that support IEEE 802.11n or earlier versions of the IEEE 802.11 standard.

The multi-antenna transmission techniques described herein may be used in combination with various wireless technologies such as Code Division Multiple Access (CDMA), Orthogonal Frequency Division Multiplexing (OFDM), Time Division Multiple Access (TDMA), Spatial Division Multiple Access (SDMA), and so on. Multiple user terminals can concurrently transmit/receive data via different (1) orthogonal code channels for CDMA, (2) time slots for TDMA, or (3) sub-bands for OFDM. A CDMA system may implement IS-2000, IS-95, IS-856, Wideband-CDMA (W-CDMA), or some other standards. An OFDM system may implement IEEE 802.11 or some other standards. A TDMA system may implement Global System for Mobile communications (GSM) or some other standards. These various standards are known in the art.

### An Example MIMO System

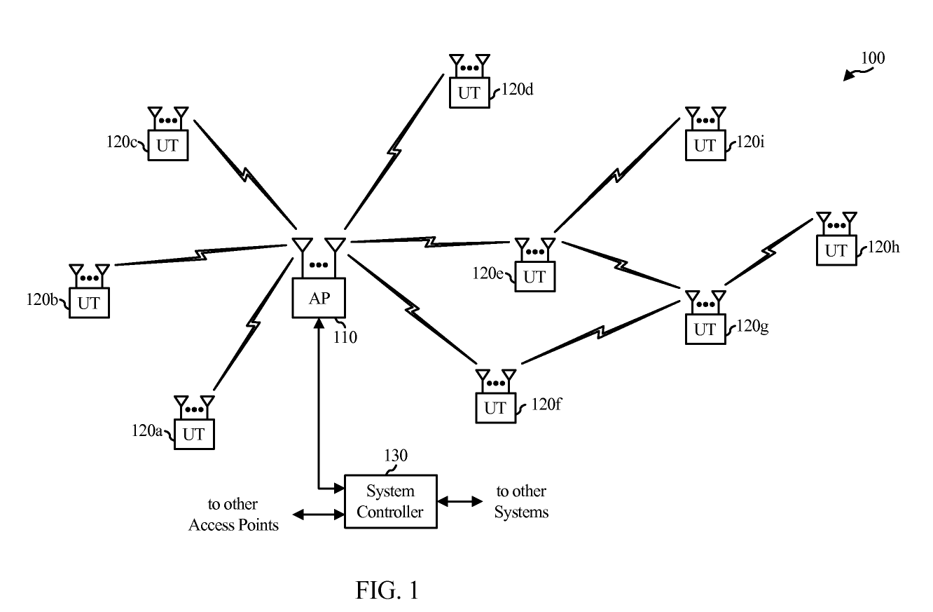

FIG. 1 illustrates a multiple-access MIMO system 100 with access points and user terminals. For simplicity, only one access point 110 is shown in FIG. 1. An access point (AP) is generally a fixed station that communicates with the user terminals and may also be referred to as a base station, a Node B, an evolved Node B (eNB) or some other terminology. A user terminal may be fixed or mobile and may also be referred to as a mobile station, a station (STA), a client, a wireless device, or some other terminology. A user terminal may be a wireless device, such as a cellular phone, a personal digital assistant (PDA), a handheld device, a wireless modem, a laptop computer, a personal computer, etc.

Access point 110 may communicate with one or more user terminals 120 at any given moment on the downlink and uplink. The downlink (i.e., forward link) is the communication link from the access point to the user terminals, and the uplink (i.e., reverse link) is the communication link from the user terminals to the access point. A user terminal may also communicate peer-to-peer with another user terminal. A system controller 130 couples to and provides coordination and control for the access points.

System 100 employs multiple transmit and multiple receive antennas for data transmission on the downlink and uplink. Access point 110 is equipped with a number Nₐₚ of antennas and represents the multiple-input (MI) for downlink transmissions and the multiple-output (MO) for uplink transmissions. A set Nᵤ of selected user terminals 120 collectively represents the multiple-output for downlink transmissions and the multiple-input for uplink transmissions. In certain cases, it may be desirable to have Nₐₚ≧Nᵤ≧1 if the data symbol streams for the Nᵤ user terminals are not multiplexed in code, frequency, or time by some means. Nᵤ may be greater than Nₐₚ if the data symbol streams can be multiplexed using different code channels with CDMA, disjoint sets of sub-bands with OFDM, and so on. Each selected user terminal transmits user-specific data to and/or receives user-specific data from the access point. In general, each selected user terminal may be equipped with one or multiple antennas (i.e., Nᵤₜ≧1). The Nᵤ selected user terminals can have the same or different number of antennas.

MIMO system 100 may be a time division duplex (TDD) system or a frequency division duplex (FDD) system. For a TDD system, the downlink and uplink share the same frequency band. For an FDD system, the downlink and uplink use different frequency bands. MIMO system 100 may also utilize a single carrier or multiple carriers for transmission. Each user terminal may be equipped with a single antenna (e.g., in order to keep costs down) or multiple antennas (e.g., where the additional cost can be supported).

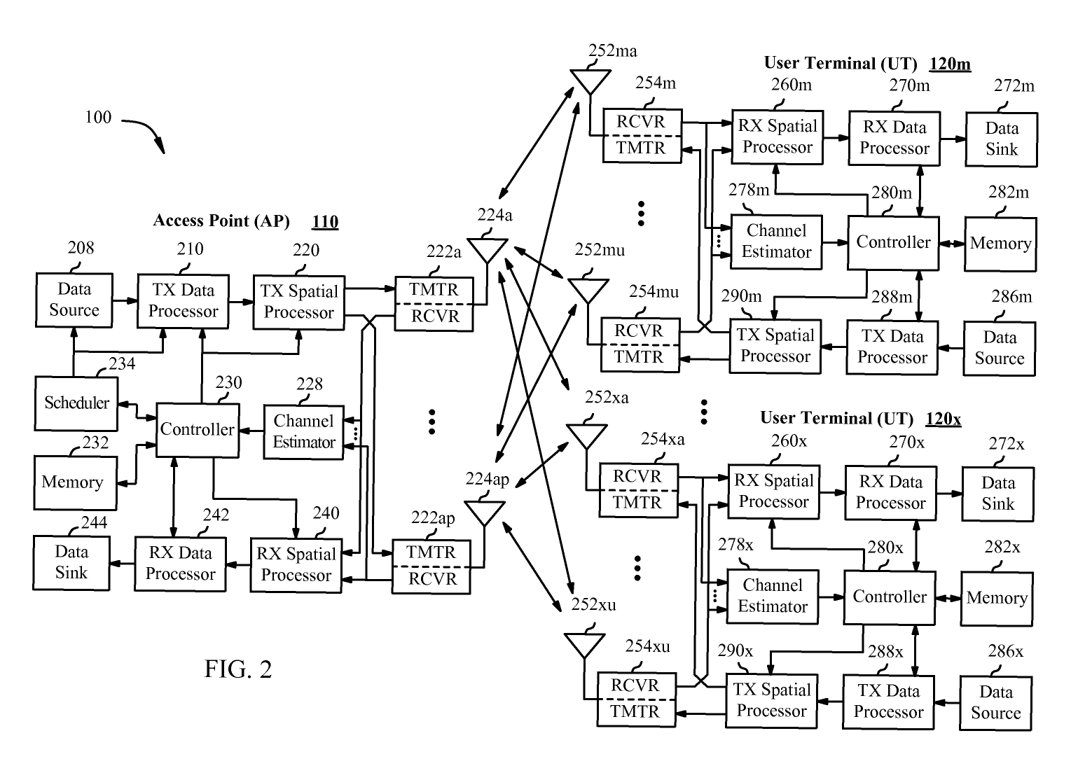

FIG. 2 shows a block diagram of access point 110 and two user terminals 120m and 120x in MIMO system 100. Access point 110 is equipped with Nₐₚ antennas 224a through 224ap. User terminal 120m is equipped with N_{ut,m} antennas 252ma through 252mu, and user terminal 120x is equipped with N_{ut,x} antennas 252xa through 252xu. Access point 110 is a transmitting entity for the downlink and a receiving entity for the uplink. Each user terminal 120 is a transmitting entity for the uplink and a receiving entity for the downlink. As used herein, a “transmitting entity” is an independently operated apparatus or device capable of transmitting data via a frequency channel, and a “receiving entity” is an independently operated apparatus or device capable of receiving data via a frequency channel. In the following description, the subscript “dn” denotes the downlink, the subscript “up” denotes the uplink, Nᵤₚ user terminals are selected for simultaneous transmission on the uplink, N_{dn} user terminals are selected for simultaneous transmission on the downlink, Nᵤₚ may or may not be equal to N_{dn}, and Nᵤₚ and N_{dn} may be static values or can change for each scheduling interval. The beam-steering or some other spatial processing technique may be used at the access point and user terminal.

On the uplink, at each user terminal 120 selected for uplink transmission, a TX data processor 288 receives traffic data from a data source 286 and control data from a controller 280. The controller 280 may also be attached to a memory 282. TX data processor 288 processes (e.g., encodes, interleaves, and modulates) the traffic data {d_{up,m}} for the user terminal based on the coding and modulation schemes associated with the rate selected for the user terminal and provides a data symbol stream {s_{up,m}}. A TX spatial processor 290 performs spatial processing on the data symbol stream {s_{up,m}} and provides N_{ut,m} transmit symbol streams for the N_{ut,m} antennas. Each transmitter unit (TMTR) 254 receives and processes (e.g., converts to analog, amplifies, filters, and frequency upconverts) a respective transmit symbol stream to generate an uplink signal. N_{ut,m} transmitter units 254 provide N_{ut,m} uplink signals for transmission from N_{ut,m} antennas 252 to the access point 110.

A number Nᵤₚ of user terminals may be scheduled for simultaneous transmission on the uplink. Each of these user terminals performs spatial processing on its data symbol stream and transmits its set of transmit symbol streams on the uplink to the access point.

At access point 110, Nₐₚ antennas 224a through 224ap receive the uplink signals from all Nᵤₚ user terminals transmitting on the uplink. Each antenna 224 provides a received signal to a respective receiver unit (RCVR) 222. Each receiver unit 222 performs processing complementary to that performed by transmitter unit 254 and provides a received symbol stream. An RX spatial processor 240 performs receiver spatial processing on the Nₐₚ received symbol streams from Nₐₚ receiver units 222 and provides Nᵤₚ recovered uplink data symbol streams. The receiver spatial processing is performed in accordance with the channel correlation matrix inversion (CCMI), minimum mean square error (MMSE), successive interference cancellation (SIC), or some other technique. Each recovered uplink data symbol stream {s_{up,m}} is an estimate of a data symbol stream {s_{up,m}} transmitted by a respective user terminal. An RX data processor 242 processes (e.g., demodulates, deinterleaves, and decodes) each recovered uplink data symbol stream {s_{up,m}} in accordance with the rate used for that stream to obtain decoded data. The decoded data for each user terminal may be provided to a data sink 244 for storage and/or a controller 230 for further processing. The controller 230 may also be attached to a memory 232.

On the downlink, at access point 110, a TX data processor 210 receives traffic data from a data source 208 for N_{dn} user terminals scheduled for downlink transmission, control data from a controller 230, and possibly other data from a scheduler 234. The various types of data may be sent on different transport channels. TX data processor 210 processes (e.g., encodes, interleaves, and modulates) the traffic data for each user terminal based on the rate selected for that user terminal TX data processor 210 provides N_{dn} downlink data symbol streams for the N_{dn} user terminals. A TX spatial processor 220 performs spatial processing on the N_{dn} downlink data symbol streams, and provides Nₐₚ transmit symbol streams for the Nₐₚ antennas. Each transmitter unit (TMTR) 222 receives and processes a respective transmit symbol stream to generate a downlink signal. Nₐₚ transmitter units 222 provide Nₐₚ downlink signals for transmission from Nₐₚ antennas 224 to the user terminals.

At each user terminal 120, N_{ut,m} antennas 252 receive the Nₐₚ downlink signals from access point 110. Each receiver unit (RCVR) 254 processes a received signal from an associated antenna 252 and provides a received symbol stream. An RX spatial processor 260 performs receiver spatial processing on N_{ut,m} received symbol streams from N_{ut,m} receiver units 254 and provides a recovered downlink data symbol stream {s_{dn,m}} for the user terminal. The receiver spatial processing is performed in accordance with the CCMI, MMSE, or some other technique. An RX data processor 270 processes (e.g., demodulates, deinterleaves, and decodes) the recovered downlink data symbol stream to obtain decoded data for the user terminal.

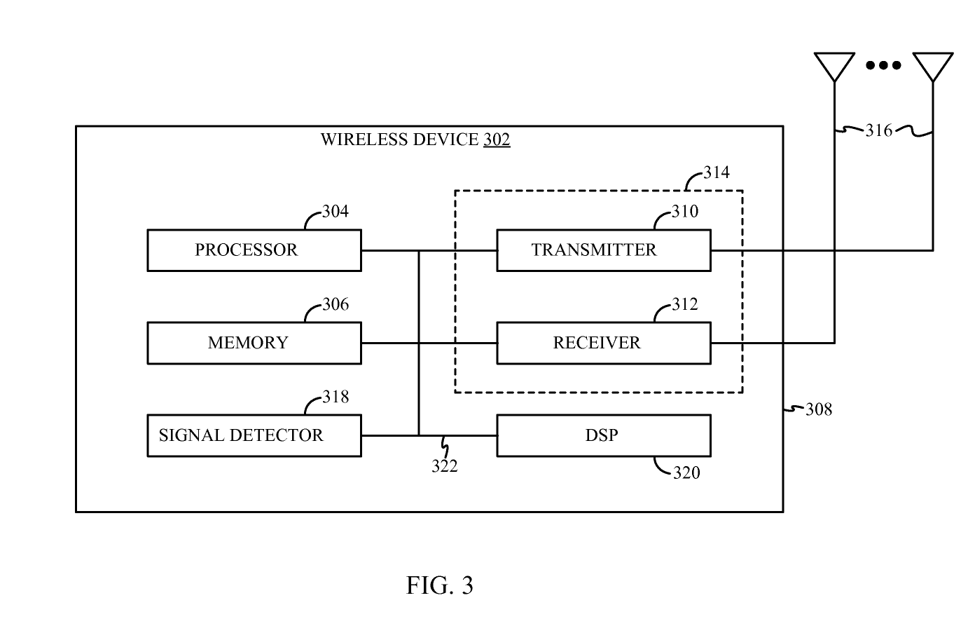

FIG. 3 illustrates various components that may be utilized in a wireless device 302 that may be employed within the system 100. The wireless device 302 is an example of a device that may be configured to implement the various methods described herein. The wireless device 302 may be an access point 110 or a user terminal 120.

The wireless device 302 may include a processor 304 which controls operation of the wireless device 302. The processor 304 may also be referred to as a central processing unit (CPU). Memory 306, which may include both read-only memory (ROM) and random access memory (RAM), provides instructions and data to the processor 304. A portion of the memory 306 may also include non-volatile random access memory (NVRAM). The processor 304 typically performs logical and arithmetic operations based on program instructions stored within the memory 306. The instructions in the memory 306 may be executable to implement the methods described herein.

The wireless device 302 may also include a housing 308 that may include a transmitter 310 and a receiver 312 to allow transmission and reception of data between the wireless device 302 and a remote location. The transmitter 310 and receiver 312 may be combined into a transceiver 314. A plurality of transmit antennas 316 may be attached to the housing 308 and electrically coupled to the transceiver 314. The wireless device 302 may also include (not shown) multiple transmitters, multiple receivers, and multiple transceivers.

The wireless device 302 may also include a signal detector 318 that may be used in an effort to detect and quantify the level of signals received by the transceiver 314. The signal detector 318 may detect such signals as total energy, energy per subcarrier per symbol, power spectral density and other signals. The wireless device 302 may also include a digital signal processor (DSP) 320 for use in processing signals.

The various components of the wireless device 302 may be coupled together by a bus system 322, which may include a power bus, a control signal bus, and a status signal bus in addition to a data bus.

Those skilled in the art will recognize the techniques described herein may be generally applied in systems utilizing any type of multiple access schemes, such as SDMA, OFDMA, CDMA, SDMA, and combinations thereof.

### Uplink SDMA Transmit Opportunity Scheduling

Certain aspects of the present disclosure present medium access control (MAC) protocols for uplink SDMA transmissions by one or more stations (STAs). In some cases, uplink SDMA may also be referred to as uplink multi-user multiple-input multiple-output (MU-MIMO), uplink OFDMA, or more generally, as uplink MU. An access point may receive one or more requests for uplink SDMA transmission from a plurality of stations. The access point may schedule the transmissions and send a message to the stations. The message may include parameters of the uplink SDMA transmissions such as starting time, duration of the transmission, spatial streams assigned to each station, and so on.

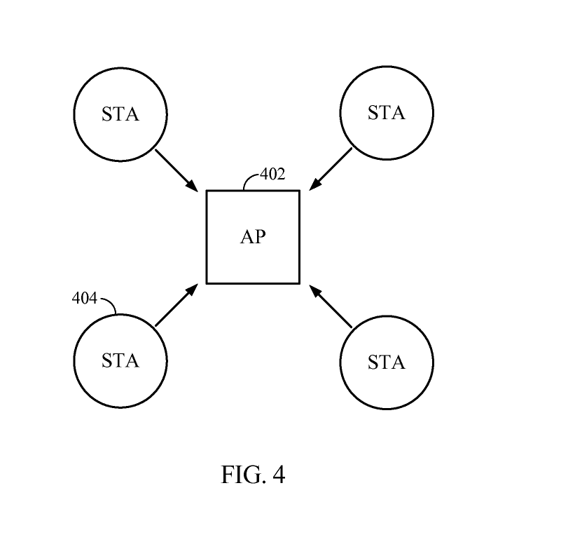

FIG. 4 illustrates an example network consisting of an access point and a plurality of stations, in accordance with certain aspects of the present disclosure. Utilizing uplink SDMA transmission, two or more of the STAs 404 may transmit data to the access point 402 simultaneously.

In wireless networks utilizing the IEEE 802.11 standard, a Request to Send (RTS)/Clear to Send (CTS) procedure may be used to reserve a portion of a wireless medium for a pending data transmission. However, for uplink SDMA, one or more uplink transmissions (i.e., transmit opportunities (TXOP)) from one or more stations may occur in parallel and at the same time.

For certain aspects of the present disclosure, during an uplink SDMA TXOP, a plurality of stations may transmit to an access point simultaneously. Each STA may use different spatial streams. The AP may schedule uplink SDMA transmissions of different stations and assign one or more spatial streams to each of the stations through a TXOP Start (TXS) frame.

For certain aspects, an AP may enable uplink SDMA at selected STAs and for selected Access Categories (ACs) within those STAs. An Access Category is an equivalent of a frame queue that contends for medium access independent of the other ACs inside an STA. A STA may have four internal ACs. Contention access may be based on Enhanced Distributed Channel Access (EDCA) (i.e., the IEEE 802.11e standard). The EDCA supports differentiated and distributed access to the wireless medium supporting different access categories such as voice, video, best effort and background.

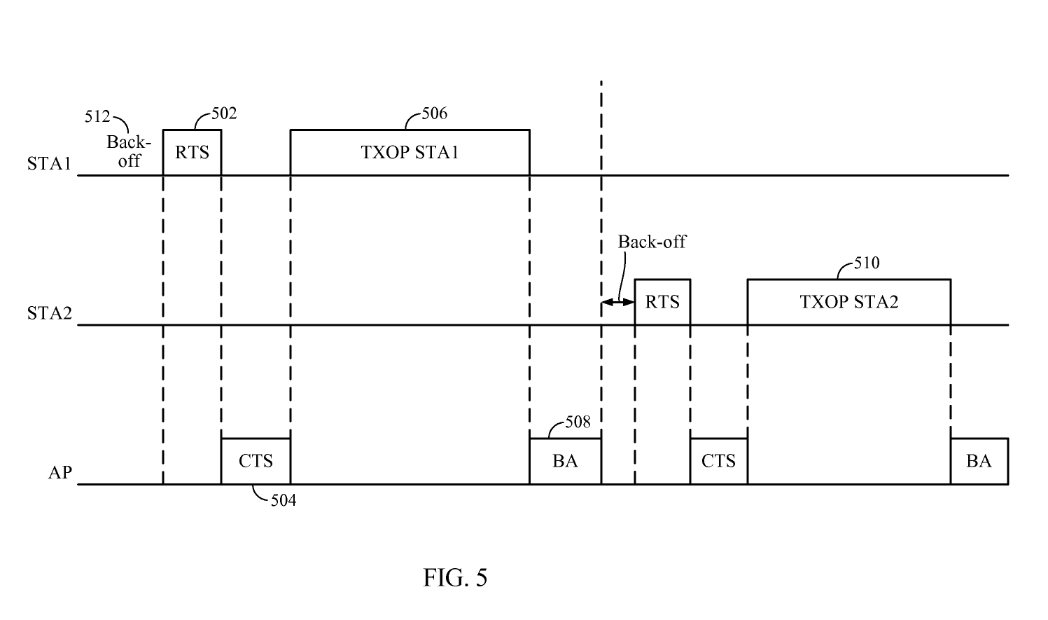

FIG. 5 illustrates message exchange between an access point and two stations utilizing EDCA procedure. As illustrated, when a back-off timer 512 for STA1 expires, STA1 may send an RTS message 502 to the AP. The AP may send a CTS message 504 in response to the RTS. STA1 may then transmit its data in TXOP STA1 506. The access point may acknowledge reception of the data from STA1 by transmitting a block acknowledgement (BA) message 508. During the time that STA1 is transmitting, STA2 may monitor the wireless medium. When STA1 finishes its transmissions, STA2 may transmit an RTS message to the AP to request access to the wireless medium. The AP may also transmit a CTS message and receive transmissions from STA2.

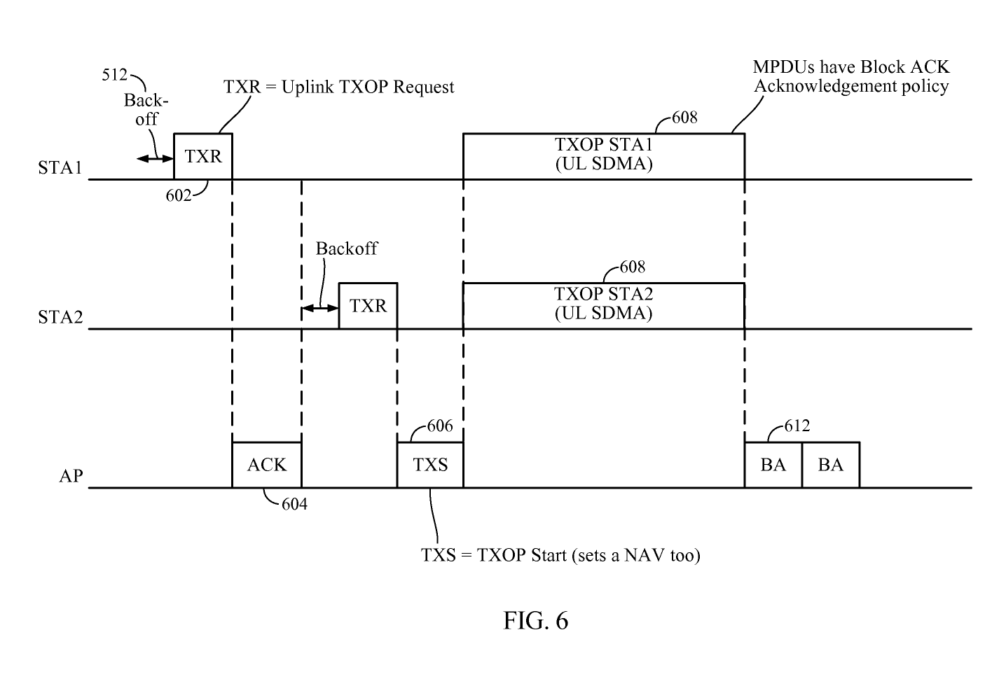

FIG. 6 illustrates message exchange between an access point and two stations utilizing uplink SDMA procedure, in accordance with certain aspects of the present disclosure. The stations are capable of uplink SDMA transmission and uplink SDMA is enabled. An STA may send a TXOP Request (TXR) 602 to the AP instead of sending an RTS 502 (FIG. 5). The TXR is sent when an AC in the STA, that is capable of performing uplink SDMA, gains access to the wireless medium. The TXR 602 may also specify which AC has gained access to the medium (e.g., a back-off timer for the AC has reached zero or expired).

For certain aspects, the AP may start an uplink SDMA TXOP 608 by sending a TXOP Start (TXS) 606 frame to the stations when it received a sufficient number of TXR frames. The TXS frame may specify STA Identifiers (IDs) for the STAs that are included in the uplink SDMA TXOP 608, the spatial streams that are assigned to each of the STAs, and the duration of the uplink SDMA TXOP. The TXS frame may also set a network allocation vector (NAV) for the duration of the uplink SDMA TXOP 608. The NAV may cause other stations that are not participating in uplink SDMA transmissions, to hold off on their transmissions until the uplink SDMA duration is finished. The access point may transmit one or more acknowledgement frames 612 to the STAs to acknowledge reception of the one or more SDMA transmissions.

For certain aspects, the AP may start an uplink SDMA TXOP when a time threshold value is exceeded after receiving a TXR from a STA without receiving additional TXR frames from other STAs.

During the uplink SDMA TXOP 608, a plurality of STAs may transmit data using the spatial streams that are assigned to them in the TXS frame. The transmissions may contain one or more MAC Service Data Units (MSDUs) that are aggregated using Aggregated MSDU (A-MSDU) and one or more MAC Protocol Data Units (MPDUs) that are aggregated using Aggregated MPDU (A-MPDU), or both.

For certain aspects, the MPDUs in the uplink SDMA transmission may indicate an acknowledgement (ACK) policy that does not require an immediate response by the AP. For instance, a Block ACK acknowledgement policy may be used on the uplink transmissions instead of an implicit Block Acknowledgement Request (BAR) acknowledgement policy that is normally used. The uplink transmissions may include a BAR frame, that may request the AP to send a Block Acknowledgement (BA) 612 frame in the next available TXOP for the AP.

For certain aspects, at the end of the uplink SDMA TXOP, the AP may send the requested BA frames. The AP may send the BA frames for one or more stations sequentially. For example, the AP may send a first BA frame 612 for a first station when a Short Inter-frame Space (SIFS) time is passed after the end of the uplink SDMA TXOP 608. The AP may send a second BA frame for the second station when a SIFS time is passed after the end of transmission of the first BA. Accordingly, the BA frames for multiple stations may be separated with SIFS durations.

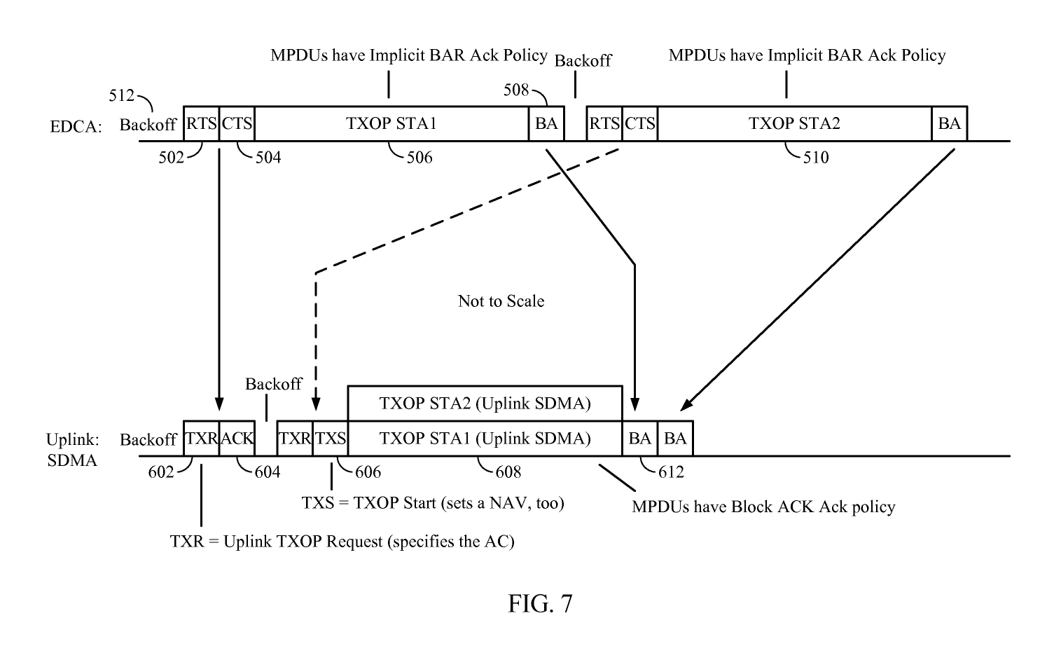

FIG. 7 illustrates a comparison between a regular enhanced distributed channel access (EDCA) and a proposed uplink SDMA protocol, in accordance with certain aspects of the present disclosure. The top portion of the figure illustrates packet exchange between an access point and two stations using EDCA procedure, when the stations do not have the ability to perform uplink SDMA. The lower portion of the figure illustrates packet exchange between the access point and two stations using uplink SDMA. As illustrated, since the transmissions in uplink SDMA may be performed in parallel, the time taken for the communication between the AP and a plurality of stations is much smaller in the system utilizing uplink SDMA than the system utilizing the EDCA procedure.

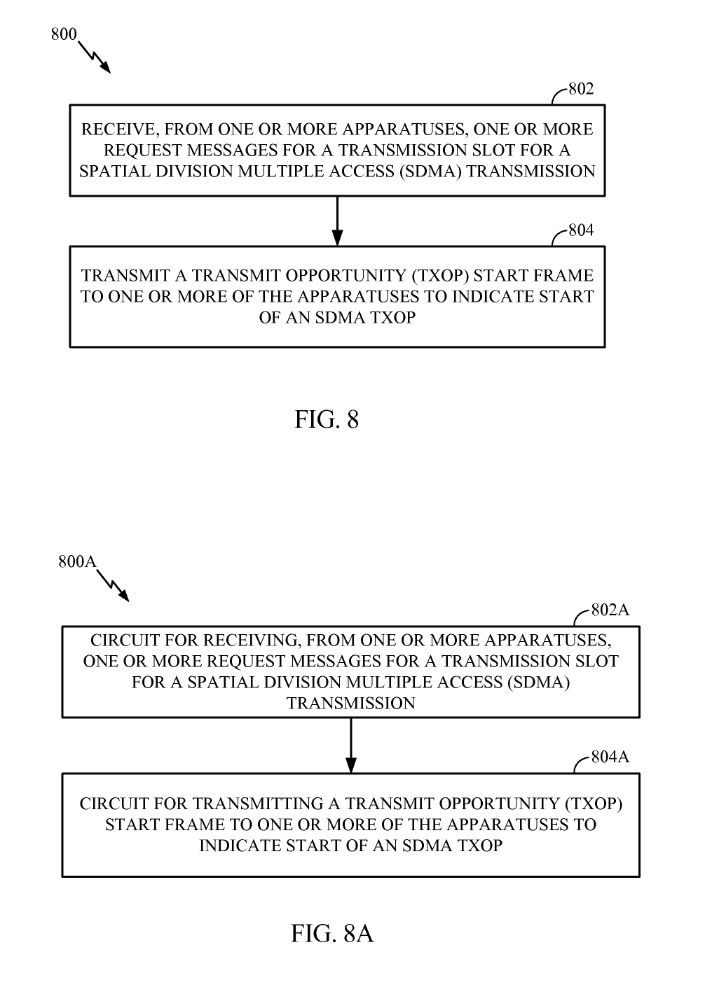

FIG. 8 illustrates example operations 800 for performing uplink SDMA that may be employed by an access point, in accordance with certain aspects of the present disclosure. At 802, one or more request messages for a transmission slot for a spatial division multiple access (SDMA) transmission may be received from one or more apparatuses (e.g., stations). At 804, the access point may transmit a transmit opportunity (TXOP) start frame to one or more of the apparatuses to indicate start of an SDMA TXOP. The access point may determine amount of resource requested by the apparatuses that sent the request messages. If the amount of resource is greater than or equal to a threshold value, the AP may transmit the TXOP start frame.

The access point may receive one or more SDMA transmissions from the apparatuses according to the TXOP start frame. At least one of the SDMA transmissions may indicate an acknowledgement policy that does not require immediate transmission of an acknowledgement frame.

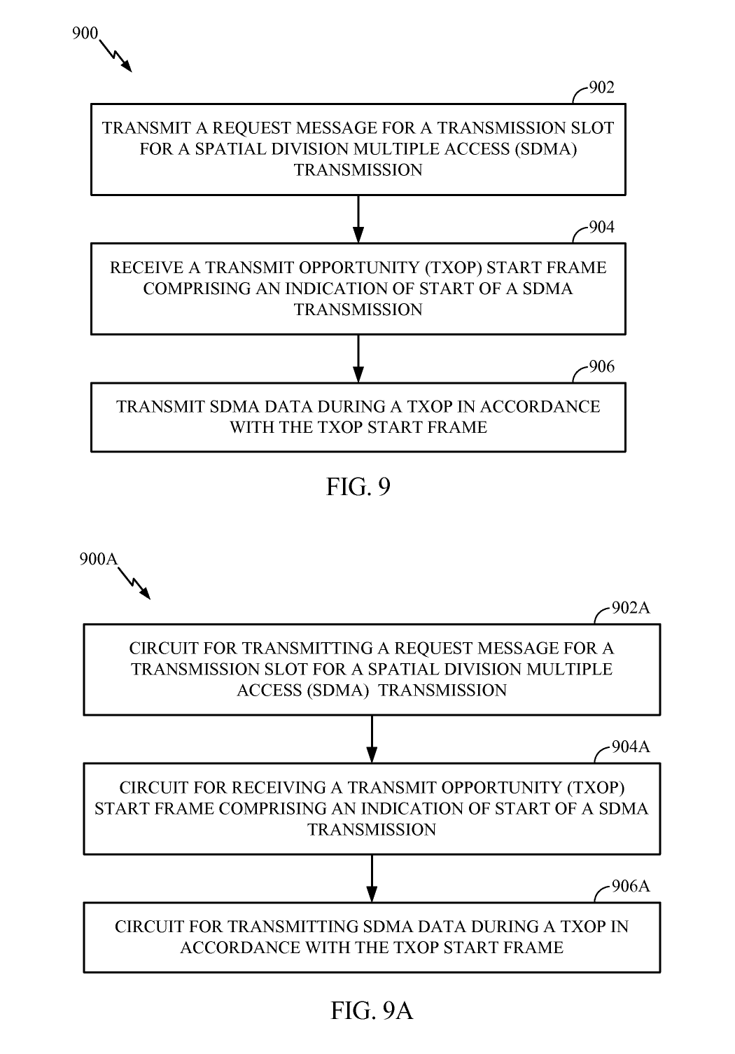

FIG. 9 illustrates example operations 900 for performing uplink SDMA that may be employed by a station, in accordance with certain aspects of the present disclosure. At 902, a request message for a transmission slot for a spatial division multiple access (SDMA) transmission is transmitted to an apparatus. At 904, a TXS frame is received from the apparatus comprising an indication of start of a SDMA transmission. At 906, SDMA data is transmitted during the TXOP in accordance with the TXOP start frame. The station may transmit the SDMA data on one or more spatial streams utilizing an assigned duration for the TXOP, wherein the spatial streams and the assigned duration are received in the TXOP start frame

For certain aspects, the uplink transmissions may not include a BAR frame, and the STAs may send a BAR frame separately after the end of the uplink SDMA TXOP, using EDCA contention. The advantage of this method is that the STA can set a NAV locally through the BAR frame to clear the medium for the duration of the BA reception. The AP may provide the STAs with fixed back-off timer values that they may use for this purpose.

For certain aspects, if the AP does not receive enough TXRs to adequately schedule uplink SDMA TXOPs, the AP may disable uplink SDMA for the stations so that the stations use normal EDCA operations.

Uplink SDMA may also be referred to as uplink MU-MIMO, uplink OFDMA, or more generally, uplink multi-user (MU) (as opposed to uplink single-user (SU)). The techniques described herein are generally applicable to uplink MU (and the terms uplink MU and uplink SDMA may be used interchangeably).

According to certain aspects, instead of enabling or disabling uplink MU transmissions, as described above, an AP may determine and transmit a threshold duration (e.g., a maximum) for uplink single-user (SU) transmissions to one or more STAs. In some cases, a threshold may be provided for one or more certain access categories (ACs). When an STA has (buffered) data to transmit, that requires a transmit time longer than the threshold duration, the STA may request for an uplink MU TXOP.

For example, the STA may request an uplink MU TXOP by transmitting a TXR frame, a QoS-Null frame that indicates the buffer size at the STA, or a QoS Data frame that does not exceed the maximum duration and which indicates the buffer size at the STA. Based on the received request for an uplink MU TXOP, the AP may initiate an uplink MU TXOP.

On the other hand, when a station has data with a transmit time shorter than or equal to the threshold duration, the STA may transmit that data as an SU transmission. In other words, short data frames (i.e., data frames not exceeding the threshold duration) may be transmitted by the STA as SU transmissions, but for longer frames (i.e., data frames exceeding the threshold duration), the STA may need to request for an uplink MU TXOP.

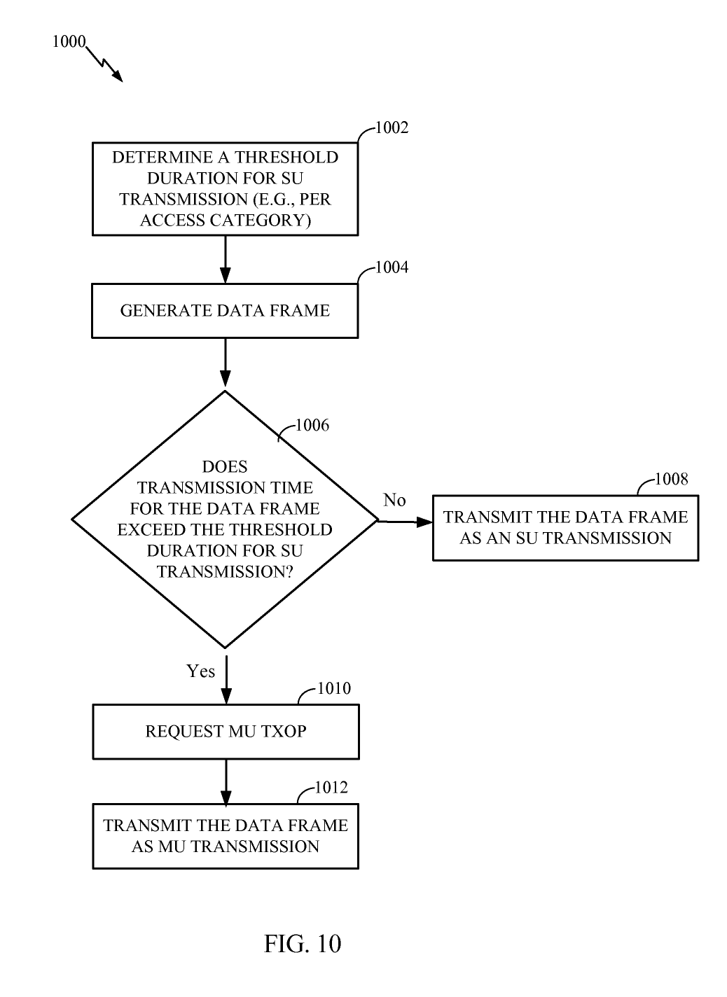

FIG. 10 illustrates example operations 1000 that may be performed, for example, by a station (STA), for transmitting using uplink SDMA or single-user (SU) transmissions.

The operations 1000 begin, at 1002, by determining a threshold duration for SU transmissions. According to certain aspects, the threshold duration may be determined per access category (AC) and may be signaled from an access point (AP).

At 1004, the STA generates a data frame and determines, at 1006, whether the transmission time for the data frame will exceed the threshold duration for SU transmissions. If the transmission time for the data frame will not exceed the threshold for SU transmissions, at 1008, the STA transmits the data frame as a SU transmission. On the other hand, if the transmission time for the data frame will exceed the threshold for SU transmissions, at 1010, the STA requests a SDMA TXOP (i.e., a MU TXOP), and transmits the data frame at 1012.

According to certain aspects, after receiving a first uplink MU TXOP request, either through a TXR or through a non-zero queue size, the AP may initiate a backoff counter with a predetermined number of backoff slots (i.e., a predetermined backoff). When this predetermined backoff expires in the absence of enough subsequent uplink MU TXOP requests being received, the AP may send a TXS frame to start an uplink MU TXOP that serves the uplink MU TXOP requests received thus far. According to certain aspects, if the AP receives enough TXOP requests to fill an uplink MU TXOP, the AP may transmit a TXS in response to the TXR that causes the uplink MU TXOP to become filled.

According to certain aspects, after transmitting an uplink MU TXOP request (either through TXR or non-zero buffer size or both), the STA may increase the backoff for the next uplink TXOP with a number of timeslots that the AP will use to initiate an uplink MU TXOP. The STA may then transmit an indication of this increased backoff to the AP.

According to certain aspects, after receiving an uplink MU TXOP, the STA may increase the backoff for the next uplink TXOP with a number of timeslots that the AP should use to initiate an uplink MU TXOP. The AP may initiate a subsequent uplink MU TXOP based on the queue size information received during the prior uplink MU TXOP.

The various operations of methods described above may be performed by any suitable means capable of performing the corresponding functions. The means may include various hardware and/or software component(s) and/or module(s), including, but not limited to a circuit, an application specific integrate circuit (ASIC), or processor. Generally, where there are operations illustrated in Figures, those operations may have corresponding counterpart means-plus-function components with similar numbering. For example, blocks 802-804 in FIG. 8 correspond to circuit blocks 802A-804A illustrated in FIG. 8A. In addition, blocks 902-906 in FIG. 9 correspond to circuit blocks 902A-906A illustrated in FIG. 9A.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, the phrase “at least one of A or B” is meant to include any combination of A and B. In other words, “at least one of A or B” comprises A or B or A and B. It could also comrpise a plurality of A, a plurality of B, or a combination of a plurality of A and a plurality of B. It should be noted that means for transmitting comprises a transmitter, means for receiving comprises a receiver, and means for determining comprises a circuit or a processor.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray disc where disks usually reproduce data magnetically, while discs reproduce data optically with lasers.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

The techniques provided herein may be utilized in a variety of applications. For certain aspects, the techniques presented herein may be incorporated in an access point station, an access terminal, a mobile handset, or other type of wireless device with processing logic and elements to perform the techniques provided herein.

While the foregoing is directed to aspects of the present invention, other and further aspects of the invention may be devised without departing from the basic scope thereof, and the scope thereof is determined by the claims that follow.

What is claimed is:

1. A method for wireless communications, comprising:
transmitting, to one or more apparatuses, an indication of a threshold duration for single-user (SU) transmissions;
receiving, from at least one of the one or more apparatuses having data with a corresponding transmission time greater than the indicated threshold duration for SU transmissions, a request message for a transmission slot for a spatial division multiple access (SDMA) transmission for transmitting the data; and
transmitting a transmit opportunity (TXOP) start frame to the at least one apparatus to indicate start of a SDMA TXOP.

2. The method of claim 1, wherein the request message comprises a TXOP Request frame.

3. The method of claim 1, wherein the request message comprises a frame indicating an amount of data buffered at the at least one apparatus.

4. The method of claim 3, wherein the frame comprises at least one of a Null frame or a data frame that does not exceed the threshold duration for SU transmissions.

5. The method of claim 3, further comprising transmitting a subsequent TXOP start frame to the at least one apparatus based on the indicated amount of data buffered at the at least one apparatus and information received in the SDMA TXOP.

6. The method of claim 1, further comprising:
starting a backoff timer in response to receiving the request message, wherein the TXOP start frame is transmitted if the backoff timer expires or a sufficient number of request messages are received prior to the backoff timer expiring.

7. A method for wireless communications, comprising:
receiving, from an access point, an indication of a threshold duration for single-user (SU) transmissions;
determining a transmission time of data will exceed the threshold duration for SU transmissions; and
transmitting a request message for a transmission slot for a spatial division multiple access (SDMA) transmission, in response to the determination.

8. The method of claim 7, further comprising:
receiving a transmit opportunity (TXOP) start frame comprising an indication of start of a SDMA transmission; and
transmitting SDMA data during a TXOP in accordance with the TXOP start frame.

9. The method of claim 7, wherein the request message comprises a TXOP Request frame.

10. The method of claim 7, wherein the request message comprises a frame indicating an amount of data buffered at the at least one apparatus.

11. The method of claim 10, wherein the frame comprises at least one of a Null frame or a data frame that does not exceed the threshold duration for SU transmissions.

12. An apparatus for wireless communications, comprising:
means for transmitting, to one or more apparatuses, an indication of a threshold duration for single-user (SU) transmissions;
means for receiving, from at least one of the one or more apparatuses having data with a corresponding transmission time greater than the indicated threshold duration for SU transmissions, a request message for a transmission slot for a spatial division multiple access (SDMA) transmission for transmitting the data; and
means for transmitting a transmit opportunity (TXOP) start frame to the at least one apparatus to indicate start of a SDMA TXOP.

13. An apparatus for wireless communications, comprising:
means for receiving, from an access point, an indication of a threshold duration for single-user (SU) transmissions;
means for determining a transmission time of data will exceed the threshold duration for SU transmissions; and
means for transmitting a request message for a transmission slot for a spatial division multiple access (SDMA) transmission, in response to the determination.

14. A computer-program product for wireless communications, comprising a computer-readable medium comprising instructions executable for:
transmitting, to one or more apparatuses, an indication of a threshold duration for single-user (SU) transmissions;
receiving, from at least one of the one or more apparatuses having data with a corresponding transmission time greater than the indicated threshold duration for SU transmissions, a request message for a transmission slot for a spatial division multiple access (SDMA) transmission for transmitting the data; and
transmitting a transmit opportunity (TXOP) start frame to the at least one apparatus to indicate start of a SDMA TXOP.

15. A computer-program product for wireless communications, comprising a computer-readable medium comprising instructions executable for:
receiving, from an access point, an indication of a threshold duration for single-user (SU) transmissions;
determining a transmission time of data will exceed the threshold duration for SU transmissions; and
transmitting a request message for a transmission slot for a spatial division multiple access (SDMA) transmission, in response to the determination.

16. An access point for wireless communications, comprising:
a plurality of antennas;
a transmitter for transmitting via the plurality of antennas, to one or more apparatuses, an indication of a threshold duration for single-user (SU) transmissions; and
a receiver for receiving via the plurality of antennas, from at least one of the one or more apparatuses having data with a corresponding transmission time greater than the indicated threshold duration for SU transmissions, a request message for a transmission slot for a spatial division multiple access (SDMA) transmission for transmitting the data;
wherein the transmitter is also for transmitting via the plurality of antennas a transmit opportunity (TXOP) start frame to the at least one apparatus to indicate start of a SDMA TXOP.

17. A station for wireless communications, comprising:
at least one antenna;
a receiver for receiving via the at least one antenna, from an access point, an indication of a threshold duration for single-user (SU) transmissions;
a processing system configured to determine a transmission time of data will exceed the threshold duration for SU transmissions; and
a transmitter for transmitting via the at least one antenna a request message for a transmission slot for a spatial division multiple access (SDMA) transmission, in response to the determination.
